(19) United States
(12) Patent Application Publication
(10) Pub. No.: US 2025/0358779 A1
(43) Pub. Date: Nov. 20, 2025

(54) WIRELESS COMMUNICATION TERMINAL AND COMMUNICATION METHOD

(71) Applicant: JVCKENWOOD Corporation, Yokohama-shi (JP)

(72) Inventor: Reo Hasegawa, Yokohama-shi (JP)

(21) Appl. No.: 19/287,862

(22) Filed: Aug. 1, 2025

Related U.S. Application Data
(63) Continuation of application No. PCT/JP2024/003800, filed on Feb. 6, 2024.

(30) Foreign Application Priority Data
Feb. 24, 2023 (JP) 2023-027354

(51) Int. Cl. H04W 64/00; H04W 76/10

(52) U.S. Cl. CPC H04W 64/00; H04W 76/10

(57) ABSTRACT

A wireless communication terminal includes a first communication unit, a second communication unit that performs second wireless communication, a storage unit that stores distance information, a position information acquisition unit that acquires position information of an own terminal and a connection destination terminal, a distance calculation unit that calculates a distance from the position information, and a communication control unit that controls the first communication unit and the second communication unit. In a state in which the first communication unit is switched from the normal communication mode to a predetermined communication mode of performing continuous transmission, when the second communication unit communicably connects a wireless communication terminal, which has made a connection request, as a connection destination terminal in a second wireless communication scheme, the position information acquisition unit acquires position information of the own terminal and position information of the connection destination terminal, and the distance calculation unit calculates a distance between the connection destination terminal and the own terminal and compares the distance information stored in the storage unit and the distance. When the distance is smaller, continuous transmission by the first wireless communication scheme is temporarily stopped and the storage unit is caused to store distance information concerning the distance. When the distance is larger, the communication connection by the second wireless communication scheme is disconnected.

### CROSS-REFERENCE TO RELATED APPLICATIONS

This application is a Continuation of PCT International Application No. PCT/JP2024/003800 filed on Feb. 6, 2024 which claims the benefit of priority from Japanese Patent Application No. 2023-027354, filed on Feb. 24, 2023, the entire contents of both of which are incorporated herein by reference.

### BACKGROUND OF THE INVENTION

### 1. Field of the Invention

The present disclosure relates to a wireless communication terminal and a communication method.

### 2. Description of the Related Art

There is known a technique in which, when an emergency situation occurs in a user having a wireless communication terminal, the wireless communication terminal enters an emergency mode and automatically transmits the fact that the user is in an emergency state to another wireless communication terminal belonging to the same group (see, for example, JP 2003-243999 A).

Transmission processing by the emergency mode sometimes causes communication interference that gives influence such as interference and congestion to normal communication processing. The wireless communication terminal being in the emergency mode is considered to indicate that an emergency situation has occurred in the user possessing the wireless communication terminal, and prompt rescue is required. Thus, it is conceivable to minimize influence such as interference and congestion by connecting, by short range wireless communication, a wireless communication terminal of a rescuer heading for rescue to a wireless communication terminal of a person requiring rescue who has entered the emergency mode and temporarily stopping transmission processing of the wireless communication terminal of the person requiring rescue while the rescuer is heading for rescue. In order for the person requiring rescue to be quickly rescued, it is desired that the person requiring rescue connects the wireless communication terminal to a wireless communication terminal of a rescuer who is present closer to the person requiring rescue. However, in the short range wireless communication in which a terminal cannot be simultaneously connected to a plurality of terminals, when the wireless communication terminal of the person requiring rescue is connected to a terminal, the wireless communication terminal of the person requiring rescue cannot be connected to another terminal. Therefore, it is likely that the wireless communication terminal of the person requiring rescue cannot appropriately communicate with another wireless communication terminal closer to wireless communication terminal of the person requiring rescue.

### SUMMARY OF THE INVENTION

It is an object of the present invention to at least partially solve the problems in the conventional technology.

The above and other objects, features, advantages and technical and industrial significance of this invention will be better understood by reading the following detailed description of presently preferred embodiments of the invention, when considered in connection with the accompanying drawings.

A wireless communication terminal according to the present disclosure comprising: a first communication unit that performs first wireless communication in a first wireless communication scheme; a second communication unit that performs second wireless communication in a second wireless communication scheme different from the first wireless communication scheme; a storage unit that stores distance information; and a control unit including a position information acquisition unit that acquires position information of an own terminal and a connection destination terminal, a distance calculation unit that calculates a distance from the position information, and a communication control unit that controls the first communication unit and the second communication unit, wherein when the second communication unit receives a connection request signal in a state in which the first communication unit is switched from a normal communication mode to a predetermined communication mode of performing continuous transmission, transmits a response signal for permitting connection, and communicably connects a wireless communication terminal, which has made a connection request, as a connection destination terminal in the second wireless communication scheme, the position information acquisition unit acquires position information of the own terminal and position information of the connection destination terminal, the distance calculation unit calculates a distance between the connection destination terminal and the own terminal and compares the distance information stored in the storage unit and the distance, when the distance is smaller, the communication control unit controls the first communication unit to temporarily stop continuous transmission by the first wireless communication scheme, and the position information acquisition unit causes the storage unit to store distance information concerning the distance, and when the distance is larger, the communication control unit controls the second communication unit to disconnect the communication connection by the second wireless communication scheme.

A wireless communication method according to the present disclosure comprising: when a second communication unit receives a connection request signal in a state in which a first communication unit is switched from a normal communication mode to a predetermined communication mode of performing continuous transmission, transmits a response signal for permitting connection, and communicably connects a wireless communication terminal, which has made a connection request, as a connection destination terminal in a second wireless communication scheme, a step of acquiring position information of an own terminal and position information of the connection destination terminal, and calculating a distance between the connection destination terminal and the own terminal; a step of comparing distance information stored in a storage unit with the distance; a step of, when the distance is smaller, controlling, by a communication control unit, the first communication unit to temporarily stop continuous transmission by a first wireless communication scheme and causing the storage unit to store distance information concerning the distance by a position information acquisition unit; and a step of, when the distance is larger, controlling, by the communication control unit, the second communication unit to disconnect the communication connection by the second wireless communication scheme.

### BRIEF DESCRIPTION OF THE DRAWINGS

FIG. 1 is a diagram illustrating a configuration example of a wireless communication system according to a first embodiment;

FIG. 2 is a diagram for explaining an overview of processing of the wireless communication terminal according to the first embodiment;

FIG. 3 is a block diagram illustrating a configuration example of a wireless communication terminal according to the first embodiment;

FIG. 4 is a flowchart illustrating processing content of the wireless communication terminal according to the first embodiment; and

FIG. 5 is a block diagram illustrating a configuration example of a wireless communication terminal according to a second embodiment.

### DETAILED DESCRIPTION OF THE PREFERRED EMBODIMENTS

Embodiments according to the present disclosure are explained in detail below with reference to the accompanying drawings. Note that the present disclosure is not limited by the embodiments and, in the embodiments explained below, redundant explanation is omitted by denoting the same parts with the same reference numerals and signs.

### First Embodiment

### Wireless Communication System

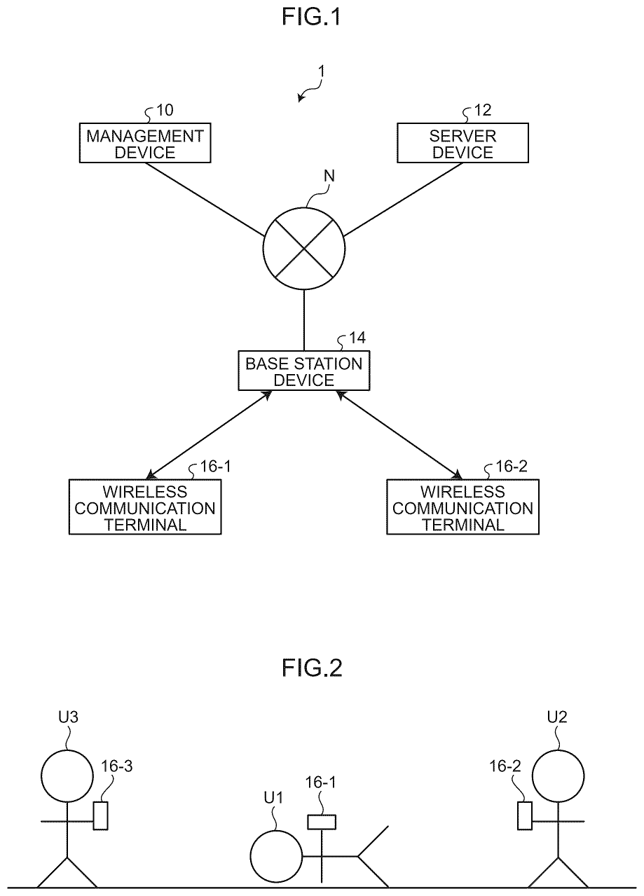

A configuration example of a wireless communication system according to a first embodiment is explained with reference to FIG. 1. FIG. 1 is a diagram illustrating the configuration example of the wireless communication system according to the first embodiment.

As illustrated in FIG. 1, a wireless communication system 1 includes a management device 10, a server device 12, a base station device 14, and a wireless communication terminal 16. In the example illustrated in FIG. 1, the wireless communication system 1 includes two wireless communication terminals 16-1 and 16-2 as the wireless communication terminal 16. However, the present disclosure is not limited to this. In the present disclosure, the number of wireless communication terminals 16 included in the wireless communication system 1 is not limited.

The management device 10, the server device 12, and the base station device 14 are communicably connected via a network N. The network N is, for example, the Internet but is not limited thereto.

The management device 10 manages communication performed on the wireless communication system 1. The management device 10 manages, for example, communication between the wireless communication terminal 16-1 and the wireless communication terminal 16-2 performed on the wireless communication system 1. The management device 10 manages, for example, various kinds of application software stored in the wireless communication terminal 16. For example, the management device 10 manages setting items concerning communication of the wireless communication terminal 16. The management device 10 can be implemented by, for example, a personal computer (PC).

The server device 12 controls communication performed on the wireless communication system 1. The server device 12 controls, for example, communication between the wireless communication terminal 16-1 and the wireless communication terminal 16-2 performed on the wireless communication system 1. The server device 12 controls, for example, various kinds of application software stored in the wireless communication terminal 16. For example, the server device 12 controls setting items concerning communication of the wireless communication terminal 16. The server device 12 can be implemented by, for example, a server PC or a cloud server.

The base station device 14 is a wireless communication device that performs wireless communication with the wireless communication terminal 16. For example, the base station device 14 transmits and receives various data to and from the wireless communication terminal 16. The base station device 14 is, for example, a wireless communication device adapted to a wireless base station for business use, a 3G (third generation mobile communication system), a 4G (fourth generation mobile communication system), or a 5G (fifth generation mobile communication system).

The wireless communication terminal 16 is a terminal device used by a user on the wireless communication system 1. The user on the wireless communication system 1 can talk with, using the wireless communication terminal 16, another user having another wireless communication terminal 16. The wireless communication terminal 16 has a function of, when an emergency situation requiring rescue occurs in the user, switching a communication mode from a normal communication mode to a predetermined communication mode and notifying the user that the emergency situation has occurred. Here, the predetermined communication mode is preferably an emergency mode involving transmission processing for notifying an emergency situation by automatic transmission not involving PTT operation. The predetermined communication mode may be a communication mode in which only emergency transmission not involving alarm is performed by automatic transmission not involving PTT operation. The normal communication mode is an operation mode in which normal communication such as a call is performed. The emergency mode is an operation mode for notifying the user that an emergency situation has occurred. The wireless communication terminal 16 switches the emergency mode to the normal communication mode when a predetermined condition is satisfied after the normal communication mode is switched to the emergency mode. The wireless communication terminal 16 may be configured by one device or may be configured by a plurality of devices. A configuration of the wireless communication terminal 16 is explained below.

### Overview of Processing of the Wireless Communication Terminal

An overview of processing of the wireless communication terminal according to the first embodiment is explained with reference to FIG. 2. FIG. 2 is a diagram for explaining the overview of the processing of the wireless communication terminal according to the first embodiment.

FIG. 2 illustrates a user U1, a user U2, and a user U3. The user U1 uses the wireless communication terminal 16-1, the user U2 uses the wireless communication terminal 16-2, and the user U3 uses a wireless communication terminal 16-3. When detecting that the user U1 has fallen, the wireless communication terminal 16-1 switches the communication mode to the emergency mode. The wireless communication terminal 16-1 switches to the communication mode to the emergency mode, sounds an alarm, executes an emergency operation of repeating continuous transmission by a first wireless communication scheme, that is, wireless transmission processing and waiting processing, and starts waiting processing by a second wireless communication scheme. Here, in the continuous transmission, the wireless transmission processing may be continuously performed by automatic transmission not involving PTT operation. In the continuous transmission, the wireless transmission processing may be intermittently performed by the automatic transmission not involving PTT operation. When the wireless communication terminal 16-2 receives a radio signal from the wireless communication terminal 16-1, the user U2 goes to rescue the user U1. When the distance between the user U1 and the user U2 decreases to a predetermined distance or less, communication connection is established between the wireless communication terminal 16-1 and the wireless communication terminal 16-2 by short range wireless communication. Here, it is assumed that the user U3 also goes to rescue the user U1 and further approaches the user U1 than the user U2. In this case, since the wireless communication terminal 16-1 and the wireless communication terminal 16-2 are communicably connected by the short range wireless communication, even if the user U3 further approaches the user U1 than the user U2, communication connection cannot be established between the wireless communication terminal 16-3 of the user U3 and the wireless communication terminal 16-1. Therefore, rescue activities for the user U1 are likely to be hindered. Therefore, in the present embodiment, when a predetermined condition is satisfied, the wireless communication terminal 16-1 executes processing for enabling communication connection with a closer one of the wireless communication terminal 16-2 and the wireless communication terminal 16-3.

### Wireless Communication Terminal

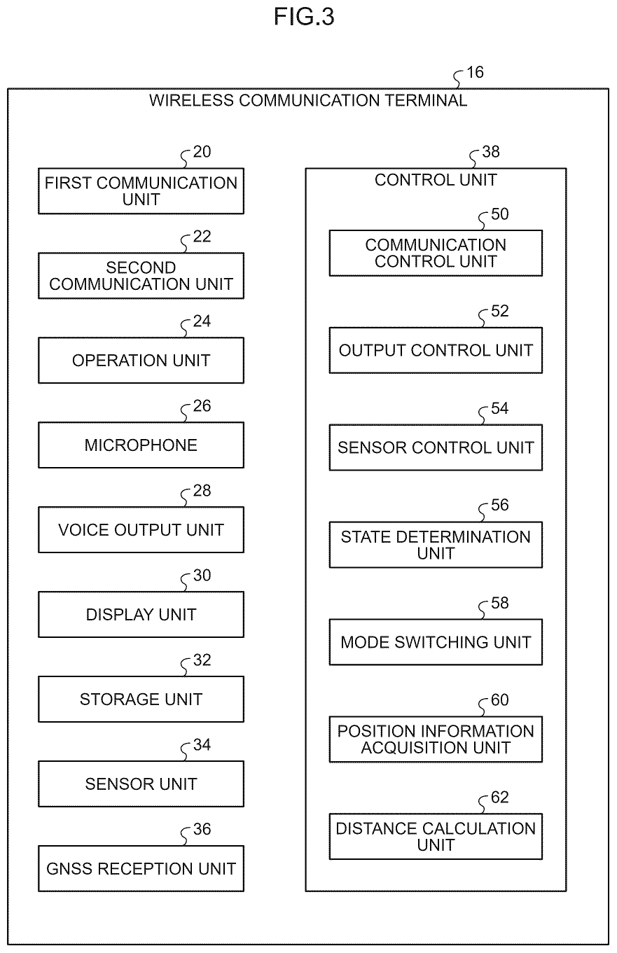

A configuration example of the wireless communication terminal according to the first embodiment is explained with reference to FIG. 3. FIG. 3 is a block diagram illustrating the configuration example of the wireless communication terminal according to the first embodiment.

As illustrated in FIG. 3, the wireless communication terminal 16 includes a first communication unit 20, a second communication unit 22, an operation unit 24, a microphone 26, a voice output unit 28, a display unit 30, a storage unit 32, a sensor unit 34, a global navigation satellite system (GNSS) reception unit 36, and a control unit 38. The wireless communication terminal 16 is, for example, a wireless device for business use but is not limited thereto. The wireless communication terminal 16 may be, for example, a smartphone. The wireless communication terminal 16 may be, for example, a combination of the wireless device for business use and the smartphone.

The first communication unit 20 transmits a radio frequency (RF) signal to communicate with the base station device 14 or the other wireless communication terminal 16. A scheme of communication performed by the first communication unit 20 is called first wireless communication scheme. Examples of the first wireless communication scheme include digital radio for business use such as APCO-P25 (Association of Public safety Communications Official International Project 25) and NXDN (registered trademark). The first wireless communication scheme may be, for example, wireless communication using a mobile phone network.

The second communication unit 22 transmits a short range wireless signal to communicate with the other wireless communication terminal 16. A scheme of communication performed by the second communication unit 22 is called second wireless communication scheme. Examples of the second wireless communication scheme include, but are not limited to, communication by Wi-Fi (registered trademark) and Bluetooth (registered trademark).

The wireless communication terminal 16 may include, for example, a universal serial bus (USB) communication unit configured by a USB port and the like in addition to the first communication unit 20 and the second communication unit 22.

The operation unit 24 receives various kinds of input operations to the wireless communication terminal 16. The operation unit 24 outputs an input signal corresponding to received input operation to the control unit 38. The operation unit 24 includes, for example, a touch panel, buttons, switches, a push to talk (PTT) button, and the like.

The microphone 26 is a microphone that detects a voice around the wireless communication terminal 16. The microphone 26 detects, for example, voice of a user of the wireless communication terminal 16. The microphone 26 outputs, for example, a voice signal corresponding to the detected voice to the control unit 38.

The voice output unit 28 outputs various kinds of voice. The voice output unit 28 outputs, for example, voice of the user of the other wireless communication terminal 16. The voice output unit 28 outputs, for example, an alarm when the wireless communication terminal 16 is in the emergency mode. The voice output unit 28 is a speaker.

The display unit 30 displays various videos. The display unit 30 is, for example, a display including a liquid crystal display (LCD), an organic electro-luminescence (EL) display, and the like.

The storage unit 32 stores various kinds of information. The storage unit 32 stores information such as arithmetic operation content of the control unit 38 and a program. The storage unit 32 includes, for example, at least one of a main storage device such as a random access memory (RAM) or a read only memory (ROM) and an external storage device such as a hard disk drive (HDD).

The storage unit 32 stores various kinds of application software. The storage unit 32 stores, for example, distance information between the wireless communication terminal 16 and the other wireless communication terminal 16 communicatively connected in the second wireless communication scheme by the second communication unit 22. Here, the other wireless communication terminal 16 communicatively connected to the wireless communication terminal 16 is sometimes referred to as connection destination terminal.

The sensor unit 34 detects a state of the user of the wireless communication terminal 16. The sensor unit 34 detects that the user of the wireless communication terminal 16 is in an emergency situation. The sensor unit 34 includes, for example, an inclination sensor that detects an angle of the user (the wireless communication terminal 16) with respect to the ground. The inclination sensor detects that the angle of the user with respect to the ground has decreased to a predetermined value, for example, 0 degree to detect that the user has fallen on the ground. The sensor unit 34 includes, for example, an acceleration sensor that detects acceleration. The acceleration sensor detects acceleration equal to or greater than predetermined magnitude to detect that the user has fallen on the ground. The sensor unit 34 may include only one type of a sensor or may include a plurality of types of sensors.

The GNSS reception unit 36 is configured by a GNSS receiver or the like that receives a GNSS signal from a GNSS satellite. The GNSS reception unit 36 outputs the received GNSS signal to a position information acquisition unit 60 of the control unit 38.

The control unit 38 controls the units of the wireless communication terminal 16. The control unit 38 includes, for example, an information processing device such as a central processing unit (CPU) or a micro processing unit (MPU) and a storage device such as a RAM or a ROM. The control unit 38 may be implemented by, for example, an integrated circuit such as an application specific integrated circuit (ASIC) or a field programmable gate array (FPGA). The control unit 38 may be implemented by a combination of hardware and software.

The control unit 38 includes a communication control unit 50, an output control unit 52, a sensor control unit 54, a state determination unit 56, a mode switching unit 58, a position information acquisition unit 60, and a distance calculation unit 62.

The communication control unit 50 controls the first communication unit 20 and the second communication unit 22. For example, the communication control unit 50 controls the first communication unit 20 to perform first wireless communication with the base station device 14 or the other wireless communication terminal 16 in the first wireless communication scheme. For example, the communication control unit 50 controls the first communication unit 20 to repeatedly perform wireless transmission processing and first waiting processing. The first waiting processing is, for example, waiting processing for receiving an RF signal from the other wireless communication terminal 16. For example, the communication control unit 50 controls the second communication unit 22 to perform second wireless communication with the other wireless communication terminal 16 in the second wireless communication scheme. For example, the communication control unit 50 controls the second communication unit 22 to perform second waiting processing. The second waiting processing is waiting processing for receiving a short range wireless signal from the other wireless communication terminal 16.

The output control unit 52 controls the voice output unit 28 and the display unit 30. For example, the output control unit 52 controls the voice output unit 28 to output various kinds of voice. For example, the output control unit 52 controls the display unit 30 to display various videos.

The sensor control unit 54 controls the sensor unit 34. The sensor control unit 54 controls the sensor unit 34 to detect a state of the user of the wireless communication terminal 16. For example, the sensor control unit 54 controls the sensor unit 34 to detect whether the user of the wireless communication terminal 16 is in an emergency situation. The sensor control unit 54 acquires sensor information indicating a detection result of the state of the user from the sensor unit 34.

The state determination unit 56 determines a state of the user of the wireless communication terminal 16. The state determination unit 56 determines a state of the user of the wireless communication terminal 16 based on information acquired by the sensor control unit 54 from the sensor unit 34. For example, the state determination unit 56 determines whether the user of the wireless communication terminal 16 is in an emergency situation requiring rescue.

The mode switching unit 58 switches between the normal communication mode and the emergency mode. When it is determined that the state of the user of the wireless communication terminal 16 is the emergency situation, the mode switching unit 58 switches the communication mode from the normal communication mode to the emergency mode.

The position information acquisition unit 60 acquires current position information of the wireless communication terminal 16. The position information acquisition unit 60 acquires current position information of the wireless communication terminal 16 based on a GNSS signal received by the GNSS reception unit 36.

The position information acquisition unit 60 acquires current position information of the other wireless communication terminal 16. The position information acquisition unit 60 acquires current position information of the other wireless communication terminal 16 based on a GNSS signal included in an RF signal received from the other wireless communication terminal 16.

The distance calculation unit 62 calculates the distance between the wireless communication terminal 16 and the other wireless communication terminal 16 based on the current position information of the wireless communication terminal 16 acquired by the position information acquisition unit 60 and the current position information of the other wireless communication terminal 16 acquired by the position information acquisition unit 60.

### Processing Content

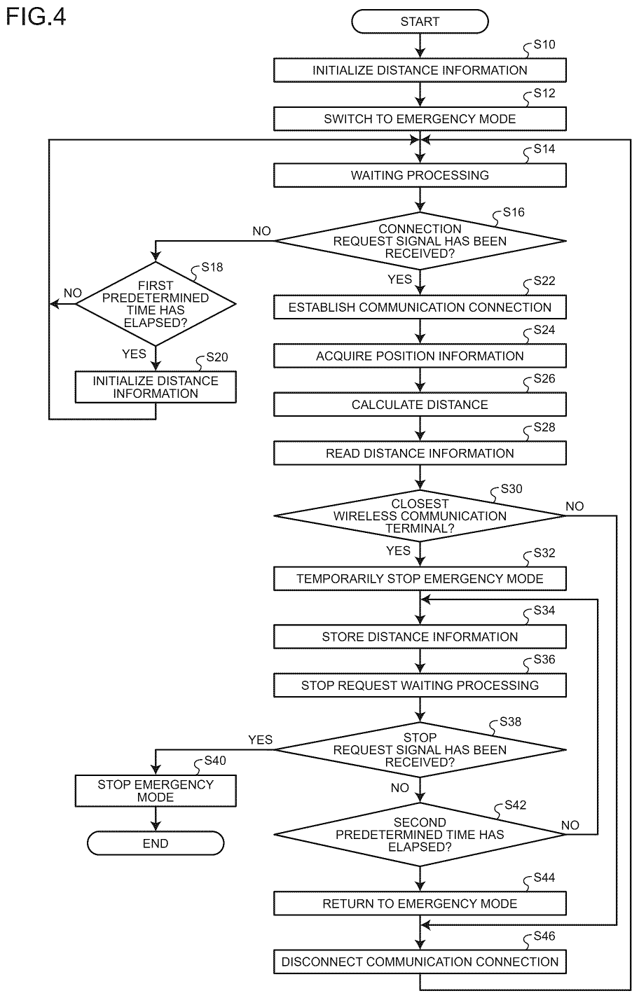

Processing content of the wireless communication terminal according to the first embodiment is explained with reference to FIG. 4. FIG. 4 is a flowchart illustrating processing content of the wireless communication terminal according to the first embodiment.

FIG. 4 illustrates a flow of processing at the time when it is determined that the user of the wireless communication terminal 16 is in an emergency state and the communication mode is switched from the normal communication mode to the predetermined communication mode. It is assumed that the predetermined communication mode here is the emergency mode.

The control unit 38 initializes the distance information concerning the distance between the wireless communication terminal 16 and the other wireless communication terminal 16 stored in the storage unit 32 (step S10). When the distance information is not stored in the storage unit 32, the control unit 38 may omit the processing in step S10. Then, the processing proceeds to step S12.

The mode switching unit 58 switches the mode set in the wireless communication terminal 16 from the normal communication mode to the emergency mode (step S12). Then, the processing proceeds to step S14.

The communication control unit 50 controls the second communication unit 22 to execute the second waiting processing by the second wireless communication scheme (step S14). Specifically, the communication control unit 50 executes an emergency operation of repeating the wireless transmission processing by the first wireless communication scheme and the waiting processing and starts the waiting processing by the second wireless communication scheme. In the waiting processing by the second wireless communication scheme, the communication control unit 50 controls the second communication unit 22 to execute processing for receiving a connection request signal indicating a request for communication connection from the other wireless communication terminal 16. Then, the processing proceeds to step S16.

The communication control unit 50 determines whether the connection request signal has been received by the second waiting processing (step S16). When it is not determined that the connection request signal has been received (step S16; No), the processing proceeds to step S18. When it is determined that the connection request signal has been received (step S16; Yes), the processing proceeds to step S22.

When it is determined No in step S16, the control unit 38 determines whether a first predetermined time determined in advance has elapsed (step S18). The first predetermined time may be optionally set. When it is determined that the first predetermined time has elapsed (step S18; Yes), the processing proceeds to step S20. When it is not determined that the first predetermined time has elapsed (step S18; No), the processing proceeds to step S14.

When it is determined as Yes in step S18, the control unit 38 initializes the distance information concerning the distance to between the wireless communication terminal 16 and the other wireless communication terminal 16 stored in the storage unit 32 (step S20). When the distance information is not stored in the storage unit 32, that is, when the distance information has been initialized, the control unit 38 may omit the processing in step S20. Then, the processing proceeds to step S14. That is, when the control unit 38 has not received the connection request signal from the other wireless communication terminal 16, the control unit 38 repeats the processing in step S14 to step S20.

When it is determined as Yes in step S16, the communication control unit 50 controls the second communication unit 22 to establish communication connection by the second wireless communication scheme between the wireless communication terminal 16 and the other wireless communication terminal 16 (step S22). Here, communication of the second wireless communication scheme by the second communication unit 22 is established by transmitting a connection permission signal, which is a response signal for accepting the connection request signal and permitting connection, to the other wireless communication terminal 16 that has transmitted the connection request signal. The other wireless communication terminal 16 to which the communication connection is established anew in step S22 is also referred to as second connection destination terminal. Then, the processing proceeds to step S24.

The position information acquisition unit 60 acquires current position information of the other wireless communication terminal 16 (step S24). Then, the processing proceeds to step S26.

The distance calculation unit 62 calculates the distance between the wireless communication terminal 16 and the other wireless communication terminal 16 based on the current position information of the wireless communication terminal 16 and the current position information of the other wireless communication terminal 16 (step S26). The distance between the wireless communication terminal 16 and the other wireless communication terminal 16 calculated in step S26 is also referred to as second distance. Then, the processing proceeds to step S28.

The distance calculation unit 62 reads the distance information concerning the distance between the wireless communication terminal 16 and the other wireless communication terminal 16 stored in the storage unit 32 (step S28). The other wireless communication terminal 16 relating to the distance information read in step S28 is also referred to as first connection destination terminal. The first connection destination terminal is another wireless communication terminal 16 closer to the wireless communication terminal 16 among other wireless communication terminals 16 connected to the wireless communication terminal 16. Distance information of the first connection destination terminal is stored in the storage unit 32. The distance between the wireless communication terminal 16 and the other wireless communication terminal 16 read in step S28 is also referred to as first distance. When the distance information is not stored in the storage unit 32, the distance calculation unit 62 may omit the processing in step S28 assuming that the distance information of the storage unit 32 is initialized. Then, the processing proceeds to step S30.

The distance calculation unit 62 determines whether the other wireless communication terminal 16 to which the communication connection is established in the second wireless communication scheme is a wireless communication terminal close from the wireless communication terminal 16 (step S30). Specifically, the distance calculation unit 62 compares the distance information read in step S28 and the distance calculated in step S26 and determines whether the other wireless communication terminal 16 to which the communication connection is established in the second wireless communication scheme is a wireless communication terminal closer from the wireless communication terminal 16. When the distance information is not stored in the storage unit 32 in step S28, the distance calculation unit 62 determines that the other wireless communication terminal 16 to which the communication connection is established in the second wireless communication scheme is a wireless communication terminal closer from the wireless communication terminal 16. When it is determined that the other wireless communication terminal 16 is a wireless communication terminal closer from the wireless communication terminal 16 (step S30; Yes), the processing proceeds to step S32. When it is not determined that the other wireless communication terminal 16 is a wireless communication terminal closer from the wireless communication terminal 16 (step S30; No), the processing proceeds to step S46.

When it is determined Yes in step S30, the mode switching unit 58 temporarily stops the emergency mode (step S32). Here, according to the temporary stop of the emergency mode by the mode switching unit 58, the communication control unit 50 controls the first communication unit 20 to temporarily stop continuous transmission of an RF signal by the first wireless communication scheme. Then, the processing proceeds to step S34.

The distance calculation unit 62 causes the storage unit 32 to store distance information concerning the distance to closer another wireless communication terminal 16 (step S34). Then, the processing proceeds to step S36. The communication control unit 50 controls the second communication unit 22 to execute stop request waiting processing by the second wireless communication scheme (step S36). Specifically, the communication control unit 50 controls the second communication unit 22 to execute the stop request waiting processing for receiving a stop request signal indicating a stop request for the emergency mode from the other wireless communication terminal 16. Then, the processing proceeds to step S38.

The communication control unit 50 determines whether the stop request signal has been received from the other wireless communication terminal 16 (step S38). When it is determined that the stop request signal is received from the other wireless communication terminal 16 (step S38; Yes), the processing proceeds to step S40. When it is not determined that the stop request signal has been received from the other wireless communication terminal 16 (step S38; No), the processing proceeds to step S42.

When it is determined Yes in step S38, the mode switching unit 58 stops the predetermined communication mode (step S40). The predetermined communication mode here is the emergency mode. Specifically, the mode switching unit 58 completely stops the continuous transmission in the emergency mode and switches the emergency mode to the normal communication mode. Then, the processing of FIG. 4 ends.

When it is determined No in step S38, the control unit 38 determines whether a predetermined second time determined in advance has elapsed (step S42). The second predetermined time may be optionally set. When it is determined that the second predetermined time has elapsed (step S42; Yes), the processing proceeds to step S44. When it is not determined that the second predetermined time has elapsed (step S42; No), the processing proceeds to step S34. That is, when the continuous transmission of the RF signal by the first wireless communication scheme in the emergency mode is temporarily stopped and the stop request signal is not received, the control unit 38 repeats the processing of steps S34, S36, S38, and S42 for the second predetermined time.

When it is determined Yes in step S42, the mode switching unit 58 returns the wireless communication terminal 16 to the emergency mode (step S44). Here, according to the return to the emergency mode by the mode switching unit 58, the communication control unit 50 controls the first communication unit 20 to resume the continuous transmission of the RF signal by the first wireless communication scheme. Then, the processing proceeds to step S46.

The communication control unit 50 controls the second communication unit 22 to disconnect the communication connection between the wireless communication terminal 16 and the other wireless communication terminal 16 by the second wireless communication scheme (step S46). Then, the processing proceeds to step S14. That is, the control unit 38 repeatedly executes the processing in step S14 to step S46 until receiving a stop request signal for the emergency mode. That is, when the communication connection is disconnected in the second communication unit 22 in a state in which the emergency mode is temporarily stopped, the communication control unit 50 causes the first communication unit 20 to restore the temporarily stopped processing and controls the first communication unit 20 to repeatedly perform the wireless transmission processing by the first wireless communication scheme and the first waiting processing. Here, when the processing proceeds to step S14, the communication control unit 50 may perform control to widen a wireless transmission interval when performing control to repeat the wireless transmission processing by the first wireless communication scheme and the waiting processing. Note that the order of the processing in step S44 and step S46 may be reversed.

As explained above, in the first embodiment, the communication connection is established based on the distances between the wireless communication terminal 16 and the plurality of other wireless communication terminals 16. Accordingly, in the first embodiment, it is possible to establish communication connection with another wireless communication terminal 16 at a shorter distance.

### First Modification of the First Embodiment

A first modification of the first embodiment is explained. In the first embodiment, whether to establish communication connection is determined based on the distance between the wireless communication terminal 16 and the other wireless communication terminal 16. In the first modification of the first embodiment, it is determined, based on the distance between the wireless communication terminal 16 and the other wireless communication terminal 16 and identification information of the other wireless communication terminal 16, whether to establish communication connection.

For example, in step S24 illustrated in FIG. 4, the control unit 38 acquires identification information for uniquely identifying the other wireless communication terminal 16 in addition to the position information of the other wireless communication terminal 16. The identification information is, for example, a unique ID set for each wireless communication terminal 16.

For example, in step S28 illustrated in FIG. 4, the control unit 38 reads the distance information and the identification information of the other wireless communication terminal 16 stored in the storage unit 32.

For example, in step S30, the control unit 38 may determine whether the identification information of the other wireless communication terminal 16 communicatively connected in step S22 and the identification information of the other wireless communication terminal 16 read in step S28 are the same. In this case, when the pieces of identification information are the same, the control unit 38 may proceed to step S32 and, when the pieces of identification information are different, the control unit 38 may determine whether the other wireless communication terminal 16 to which the communication connection is established in step S22 is a wireless communication terminal closer from the wireless communication terminal 16. That is, in the modification of the first embodiment, when communication connection with another wireless communication terminal 16 is established, a distance is not determined when the other wireless communication terminal 16 is the same as another wireless communication terminal 16 to which communication connection is established last time and a distance is determined only when the other wireless communication terminal 16 is different from the other wireless communication terminal 16 to which the communication connection is established last time.

For example, when identification information of another wireless communication terminal 16 to which communication connection is established this time and identification information of another wireless communication terminal 16 to which communication connection is established last time are different and the distance to the other wireless communication terminal 16 to which the communication connection is established last time is shorter, the control unit 38 may transmit the identification information of the other wireless communication terminal 16 to which the communication connection is established last time to the other wireless communication terminal 16 to which the communication connection is established this time.

As explained above, in the first modification of the first embodiment, communication connection is established based on the distances between the wireless communication terminal 16 and the plurality of other wireless communication terminals 16 and the identification information of the plurality of other wireless communication terminals 16. Accordingly, in the first modification of the first embodiment, it is possible to communicably connect the wireless communication terminal 16 to another wireless communication terminal 16 at a shorter distance. In the first modification of the first actual embodiment, since the processing in step S30 illustrated in FIG. 4 is executed only when the pieces of identification information are different, it is possible to reduce a processing load.

### Second Modification of the First Embodiment

A second modification of the first embodiment is explained. In the first embodiment, the wireless communication terminal 16 stops the emergency mode when receiving the stop request signal from the other wireless communication terminal 16. In the first embodiment, the distance at which the stop request signal can be received is the same as the distance at which the communication connection can be established in the second wireless communication scheme. In the second modification of the first embodiment, the distance at which the stop request signal can be received from the other wireless communication terminal 16 may be set shorter than the distance at which the communication connection can be established in the second wireless communication scheme.

For example, it is assumed that the wireless communication terminal 16 receives the stop request signal from the other wireless communication terminal 16 in a state in which the distance to the other wireless communication terminal 16 is a predetermined distance or more and stops the emergency mode. In this case, it is likely that the user of the other wireless communication terminal 16 who has gone to rescue the user of the wireless communication terminal 16 cannot find the user of the wireless communication terminal 16 because the distance to the wireless communication terminal 16 is the predetermined distance or more. Thus, the wireless communication terminal 16 may maintain the emergency mode until the distance to the other wireless communication terminal 16 decreases to the predetermined distance or less after receiving the stop request signal from the other wireless communication terminal 16. In this case, after receiving the stop request signal from the other wireless communication terminal 16, the wireless communication terminal 16 only has to stop the emergency mode at a point in time when the distance to the other wireless communication terminal 16 decreases to the predetermined distance or less.

As explained above, in the second modification of the first embodiment, after receiving the stop request signal from the other wireless communication terminal 16, the wireless communication terminal 16 maintains the emergency mode until the distance to the other wireless communication terminal 16 decreases to the predetermined distance or less. Accordingly, in the second modification of the first embodiment, it is possible to prevent another user who has gone to rescue the user of the wireless communication terminal 16 from losing sight of the user of the wireless communication terminal 16.

### Second Embodiment

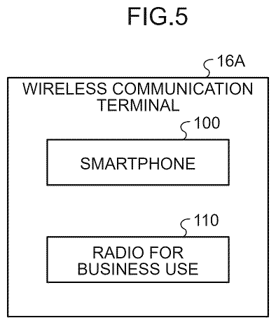

A configuration example of a wireless communication terminal according to a second embodiment is explained with reference to FIG. 5. FIG. 5 is a block diagram illustrating the configuration example of the wireless communication terminal according to the second embodiment.

As illustrated in FIG. 5, a wireless communication terminal 16A includes a smartphone 100 and a radio for business use 110. The smartphone 100 and the radio for business use 110 are communicably connected by a USB cable or the like. That is, in the present disclosure, the wireless communication terminal may include a plurality of wireless communication devices of different types.

In a service area where a radio wave of a mobile phone reaches, a user can talk with another user using the smartphone 100. While the smartphone 100 is used for a call, the radio for business use 110 functions as a speaker microphone. That is, the radio for business use 110 outputs voice received from the other user. The user inputs voice to the radio for business use 110 while pressing a PTT button of the radio for business use 110, whereby a voice signal is transmitted from the smartphone 100.

Outside the service area where the radio wave of the mobile phone does not reach, the user performs communication with the radio for business use 110 alone.

As explained above, in the second embodiment, it is possible to configure a wireless communication terminal using a plurality of communication devices of different types.

The components of the devices illustrated in the drawings are functionally conceptual and are not always required to be physically configured as illustrated in the drawings. That is, a specific form of distribution and integration of the devices is not limited to the illustrated form and all or some of the devices can be functionally or physically distributed and integrated in any unit according to various loads, usage conditions, and the like. Note that this configuration by distribution and integration may be dynamically performed.

According to the present disclosure, it is possible to provide a wireless communication terminal and a communication method that can accept a connection request from another wireless communication terminal closer to the wireless communication terminal.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A wireless communication terminal comprising:
a first communication unit that performs first wireless communication in a first wireless communication scheme;
a second communication unit that performs second wireless communication in a second wireless communication scheme different from the first wireless communication scheme;
a storage unit that stores distance information; and
a control unit including a position information acquisition unit that acquires position information of an own terminal and a connection destination terminal, a distance calculation unit that calculates a distance from the position information, and a communication control unit that controls the first communication unit and the second communication unit, wherein
when the second communication unit receives a connection request signal in a state in which the first communication unit is switched from a normal communication mode to a predetermined communication mode of performing continuous transmission, transmits a response signal for permitting connection, and communicably connects a wireless communication terminal, which has made a connection request, as a connection destination terminal in the second wireless communication scheme,
the position information acquisition unit acquires position information of the own terminal and position information of the connection destination terminal,
the distance calculation unit calculates a distance between the connection destination terminal and the own terminal and compares the distance information stored in the storage unit and the distance,
when the distance is smaller, the communication control unit controls the first communication unit to temporarily stop continuous transmission by the first wireless communication scheme, and the position information acquisition unit causes the storage unit to store distance information concerning the distance, and
when the distance is larger, the communication control unit controls the second communication unit to disconnect the communication connection by the second wireless communication scheme.

2. The wireless communication terminal according to claim 1, wherein
when the distance calculation unit compares the distance information stored in the storage unit and the distance,
when the distance information stored in the storage unit is initialized,
the communication control unit controls the first communication unit to temporarily stop the continuous transmission by the first wireless communication scheme, and
the distance calculation unit stores the distance in the storage unit as distance information.

3. The wireless communication terminal according to claim 1, wherein
when a predetermined time has elapsed without the second communication unit receiving the connection request signal in a state in which the first communication unit is switched from the normal communication mode to the predetermined communication mode of performing the continuous transmission,
the control unit performs control to initialize the distance information stored in the storage unit.

4. The wireless communication terminal according to claim 1, wherein
in a state in which the first communication unit temporarily stops the continuous transmission,
when the second communication unit receives a stop request signal from the connection destination terminal,
the communication control unit controls the first communication unit to completely stop the continuous transmission by the first wireless communication scheme.

5. A wireless communication method comprising:
when a second communication unit receives a connection request signal in a state in which a first communication unit is switched from a normal communication mode to a predetermined communication mode of performing continuous transmission, transmits a response signal for permitting connection, and communicably connects a wireless communication terminal, which has made a connection request, as a connection destination terminal in a second wireless communication scheme,
a step of acquiring position information of an own terminal and position information of the connection destination terminal, and calculating a distance between the connection destination terminal and the own terminal;
a step of comparing distance information stored in a storage unit with the distance;
a step of, when the distance is smaller, controlling, by a communication control unit, the first communication unit to temporarily stop continuous transmission by a first wireless communication scheme and causing the storage unit to store distance information concerning the distance by a position information acquisition unit; and
a step of, when the distance is larger, controlling, by the communication control unit, the second communication unit to disconnect the communication connection by the second wireless communication scheme.
